(19) United States
(12) Patent Application Publication
(10) Pub. No.: US 2021/0161628 A1
(43) Pub. Date: Jun. 3, 2021

(54) Dental Milling Disc Device

(71) Applicant: Keith Crittenden, Crete, IL (US)

(72) Inventor: Keith Crittenden, Crete, IL (US)

(21) Appl. No.: 17/110,015

(22) Filed: Dec. 2, 2020

Related U.S. Application Data
(60) Provisional application No. 62/942,550, filed on Dec. 2, 2019.

(51) Int. Cl. A61C 13/00

(52) U.S. Cl. CPC A61C 13/0022; A61C 2204/00

(57) ABSTRACT

The improved dental milling disc device is an apparatus that includes an innovative configuration of a dental milling disc and a gasket, designed to eliminate the risks of cracking and damage due to the vibration of manufacturing machines. To accomplish this, the apparatus includes at least one gasket attached perimetrically around opposing edges of the disc. Accordingly, the dental milling disc device allows the machine holder to be properly tightened to hold the disc in place while significantly reducing the risk of cracking the disc. Furthermore, the apparatus reduces the potential for the disc to rotate in the holder or move due to vibration as the gasket of the device better secures the disc in place and dampens vibrations. Additionally, the dampening effect of the apparatus helps increase the tool life. Thus, the apparatus enables an efficient and cost-effective utilization of the milling disc.

The current application claims a priority to the U.S. Provisional Patent application Ser. No. 62/942,550 filed on Dec. 2, 2019.

### FIELD OF THE INVENTION

The present invention relates generally to dental milling discs. More specifically, the present invention relates to a zirconia dental milling disc designed to reduce potential cracking and undesired movement of the disc during the manufacturing process of dental restorations

### BACKGROUND OF THE INVENTION

A common method of making dental restorations includes milling a restoration precursor out of a zirconia disc of a pre-sintered but still porous ceramic material. The market for zirconia milling discs is highly competitive, and dental laboratories are quality and price sensitive. Manufacturers of zirconia milling discs often compete in terms of price, and many are attempting to reduce costs for making their products. Most zirconia milling disc manufacturers do not use the product they produce. In addition, the manufacturing process of the zirconia milling discs exhibits a fair amount of variance. Therefore, the manufacturers of the milling machines that the zirconia disc is placed in, purposely create their disc holders with sufficient tolerance to allow discs that vary in diameter to fit their machines. However, the process of placing the disc into the holders can lead to improperly seated discs, movement of the disc during the manufacturing process, or a situation where the milling technician tightens the holder in such a way that the disc is damaged (e.g., cracked or chipped). The zirconia milling disc is strongest when brand new and before teeth have been milled from the disc. The risk of the disc cracking increases as teeth are milled from the disc. In most operations, 4-5 teeth are milled at a time, but typically 16-20 teeth are milled from a single 98 mm disc. While the risk of cracking may be lower during the initial milling session, during subsequent installations and removals, the disc becomes increasingly prone to cracking and at the fastening points sound travels best through rigid materials. Further, harmonics produced from the spindle during operation travel through the machine and are transferred to the milling disc which can lead to chipping during the milling process. Accordingly, there is a need for devices that effectively remove or reduce the undesirable consequences of the vibration of the manufacturing machine and decrease any chance of cracking of the disc due to the tightening process.

The present invention aims to solve the aforementioned problems through the innovative configuration of a disc and a gasket, designed to eliminate the risks of cracking and damage due to the vibration of manufacturing machines. Further, the present invention allows the machine holder to be properly tightened to hold the disc in place while significantly reducing the risk of cracking the disc. Furthermore, the present invention reduces the potential for the disc to rotate in the holder or move due to vibration as the gasket of the present invention better secures the disc in place and dampens vibrations. Additionally, the dampening effect of the present invention helps increase the tool life of the machine. Thus, the present invention enables an efficient and cost-effective utilization of the milling disc.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a front elevational view of the present invention.

FIG. 4 is a top-plan view of the present invention.

FIG. 5 is an exploded top-front-left perspective view of the present invention.

FIG. 6 is an exploded bottom-rear-right perspective view of the present invention.

FIG. 7 is an exploded right-side elevational view of the present invention.

FIG. 8 is a front elevational view of an alternate embodiment of the present invention.

### DETAIL DESCRIPTIONS OF THE INVENTION

All illustrations of the drawings are for the purpose of describing selected versions of the present invention and are not intended to limit the scope of the present invention.

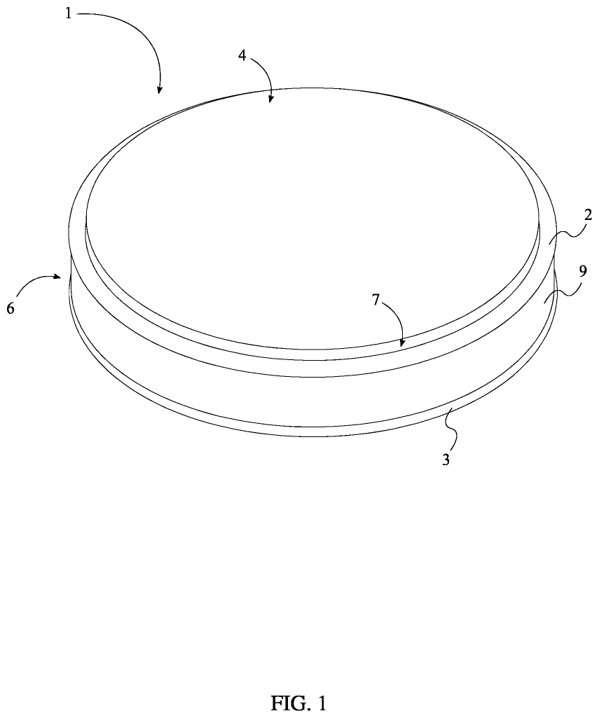

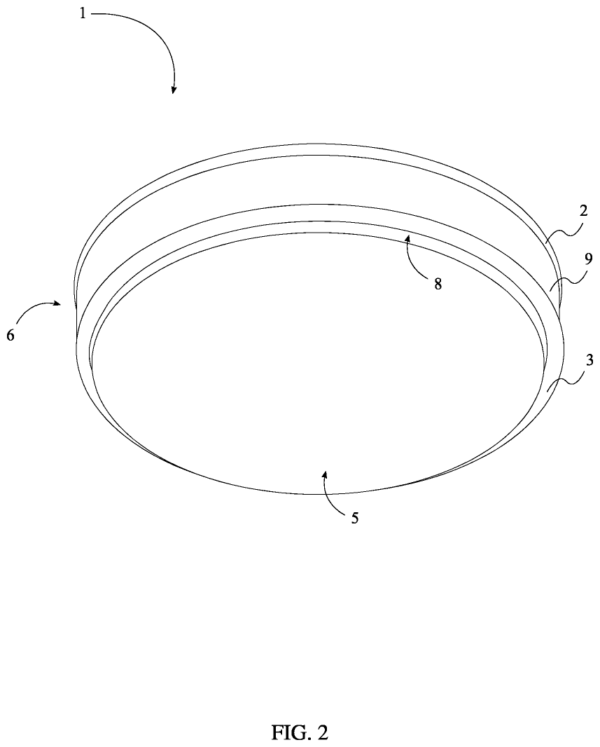

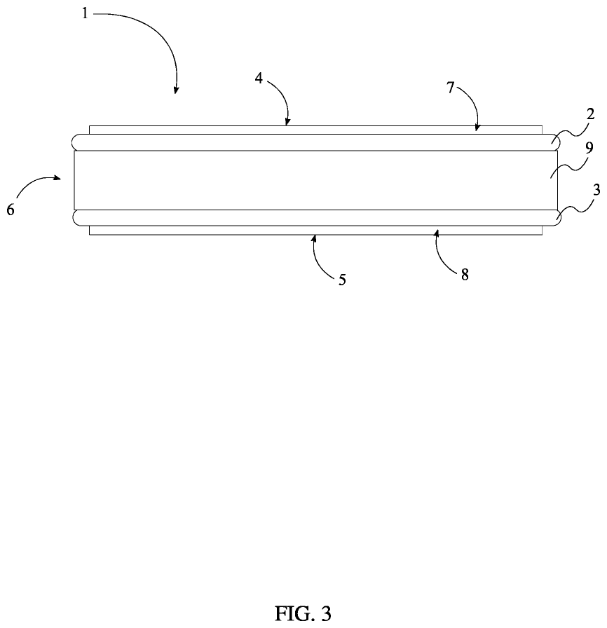

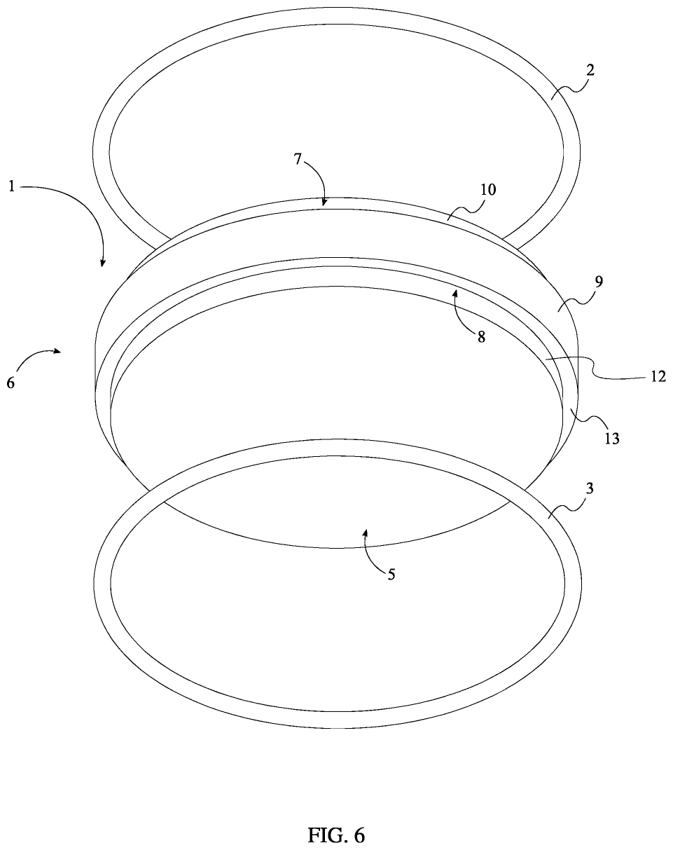

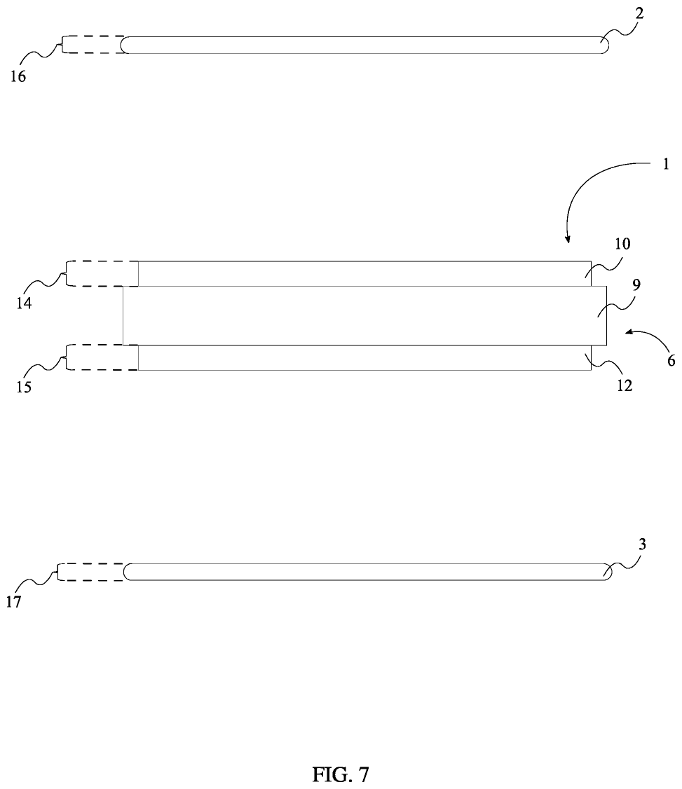

In reference to FIG. 1 through FIG. 8, the present invention is an improved dental milling disc device. An objective of the present invention is to provide users with an innovative configuration of a disc and a gasket, that is designed to eliminate the risks of cracking and damage due to the vibration of manufacturing machines. Further, the present invention allows the machine holder to be properly tightened to hold the disc in place while significantly reducing the risk of cracking the disc. Furthermore, the present invention reduces the potential for the disc to rotate in the holder or move due to vibration as the gasket of the present invention better secures the disc in place and dampens vibrations. Additionally, the dampening effect of the present invention helps increase the tool life of the milling machine. Thus, the present invention enables an efficient and cost-effective utilization of the milling disc.

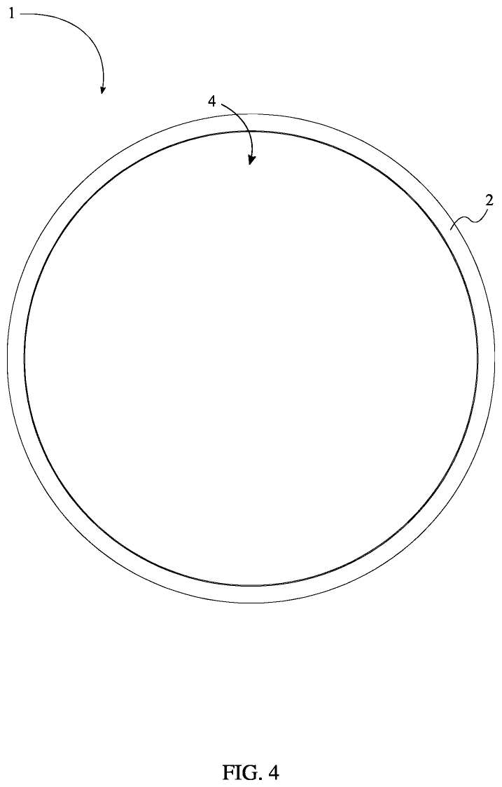

The following description is in reference to FIG. 1 through FIG. 7. According to a preferred embodiment, the present invention comprises a disc 1, a first gasket 2, and a second gasket 3. Preferably, the disc 1 is made of zirconia. It should be noted that any other advanced polycrystalline ceramic materials may also be used in the disc 1. In the preferred embodiments, the shape of the disc 1 is circular as shown in FIG. 4. However, the disc 1 may be of any suitable shape, as long as the objectives of the present invention are fulfilled. Further, the disc 1 may vary in height (thickness) from 10 mm to 30 mm so that the dental lab or milling center can select the best size for the dental crown or bridge to be milled. Zirconia powders can be combined with other materials and pressed into discs or desired shapes. In one embodiment, the disc 1 may include multiple layers that can be deposited using any of the known forming methods, including but not limited to pressing (uniaxial or isostatic), extrusion, slip casting, gel casting, pressure filtration, and injection molding. The layers may be parallel and may have a constant thickness. Alternatively, the layers may have a non-uniform thickness. Thus, it should be noted that, the disc 1 may comprise any size, shape, material, components and arrangement of components that is known to one of ordinary skill in the art, as long as the objectives of the present invention are fulfilled.

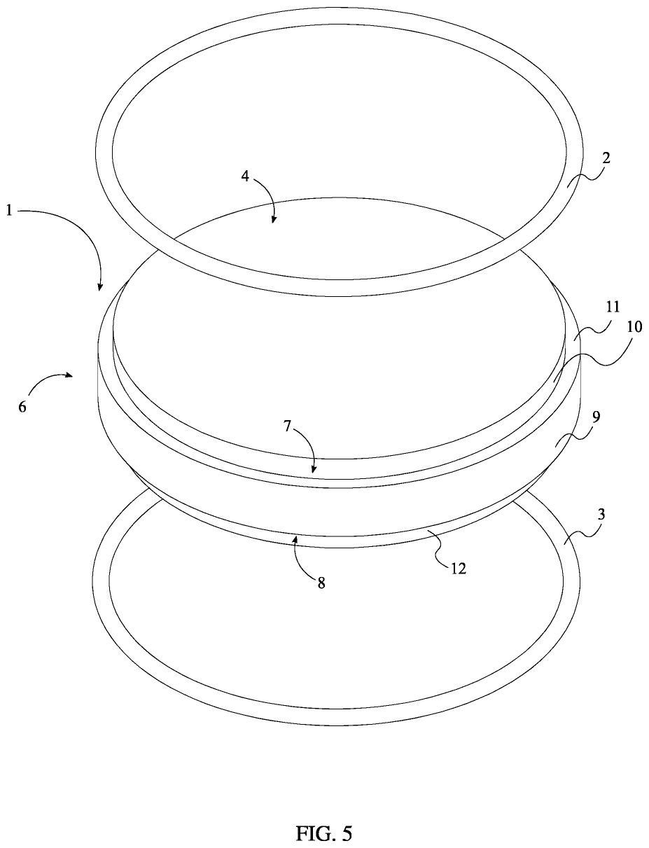

As seen in FIG. 1 through FIG. 7, the disc 1 comprises a first surface 4, a second surface 5, and at least one lateral section 6. Preferably, the first surface 4 is positioned opposite to the second surface 5 across the disc 1 in such a way that, the first surface 4 constitutes the upper surface of the disc and the second surface 5 constitutes the lower surface of the disc 1. In reference to FIG. 5 through FIG. 7, the at least one lateral section 6 comprises a first recess 7, a second recess 8, and a center section 9. Generally, the generic zirconia milling disc holder on a dental milling machine is standardized at 98.5 mm diameter. To accommodate the machine and the variance in holders across many manufacturers, zirconia and other dental milling discs are produced with a shelf (center section 9) that is 10 mm high and 2 mm wide around the entire diameter of the disc. This is a standard design specification for all 98 mm discs on the market. Accordingly, creating the first recess 7 and the second recess 8 facilitates formation of the shelf or the center section 9. Preferably, the first recess 7 and the second recess 8 laterally traverse into and around the at least one lateral section 6, such that the first recess 7 is positioned adjacent the first surface 4, and the second recess 8 is positioned adjacent the second surface 5. Preferably, a lathe machine is employed to cut ledges in the disc 1 to create the first recess 7 and the second recess 8. However, any other cutting or etching method that is known to one of ordinary skill in the art may be employed. To that end, the first recess 7 delineates a first lateral sidewall 10 and an upper ledge 11, and the second recess 8 delineates a second lateral sidewall 12 and a lower ledge 13. In other words, the first recess 7 is positioned opposite to the second recess 8 across the center section 9. Preferably, the upper ledge 11 and the lower ledge 13 span approximately 2 mm in length. However, any other dimension may be employed, as long as the intents of the present invention is fulfilled. Furthermore, the first recess 7 is positioned perimetrically around the first surface 4, and the second recess 8 is positioned perimetrically around the second surface 5, such that they do not remove any zirconia from the actual milling platform.

According to the preferred embodiment of the present invention, the first gasket 2 is mounted along the first recess 7 and adjacent the upper ledge 11, and the second gasket 3 is mounted along the second recess 8 and adjacent the lower ledge 13. Preferably, the first gasket 2 and the second gasket 3 comprise a nitrile rubber (70 Duro Buna-N) with a thickness of approximately 0.625 in/1.5875 mm. However, the first gasket 2 and the second gasket 3 may comprise any other material, thickness, size and shape, as long as the intents of the present invention are not altered.

Currently, most manufacturers produce a 98-98.5 mm disc and then use a lathe to remove sufficient material to create a 10 mm-high center section 9 on the body of the disc 1. In the present invention, more material (2 mm additional to create 8 mm center section in height) is removed, followed by adding a gasket to each side of the disc (upper and lower) with sufficient gasket thickness (e.g., around 2-3 mm). In other words, standard height of the center section 9 (band height) in the industry is 10 mm, and the present invention reduces it to 8 mm; then, adding approximately 3 mm of rubber may allow the fasteners of a holder to clamp back down to the 10 mm height. Accordingly, the first gasket 2 is attached to the upper ledge 11 and the first lateral sidewall 10 and the second gasket 3 is attached to the lower ledge 13 and the second lateral sidewall 12, thereby allowing the fasteners of the holder to clamp and attach around the first gasket 2 and the second gasket 3.

The first gasket 2 and the second gasket 3 provide for even distribution of pressure, allows for minimal force/torque, and eliminates rotation in the holder/keeper. The milling machine disc holders use 4 or 5 points of pressure to lock the milling disc into place. The improved dental milling disc device distributes the pressure more evenly, as well as has the added benefit of continuing to disperse pressure while harvesting the teeth. The first gasket 2 and the second gasket 3 further dampen vibrations associated with the milling process, which leads to smoother cut margins (less chipping and smoother finish) to the actual milled product (tooth and bridges) and increases the tool life. In other words, as the tool wears, the natural vibrations that exist in the machine transfer to the tool and cause the tool to vibrate. As the first gasket 2 and the second gasket 3, the disc holder vibrates less, creating less likelihood of chipping.

As seen in FIG. 5 through FIG. 7, the first recess 7 comprises a first depth 14 and the second recess 8 comprises a second depth 15. Preferably the first depth 14 is the distance from the first surface 4 to the upper ledge 11 and the second recess 8 is the distance from the second surface 5 to the lower ledge 13. According to the preferred embodiment, a first thickness 16 of the first gasket 2 is smaller than the first depth 14 and a second thickness 17 of the second gasket 3 is smaller than the second depth 15. This is so that, the first gasket 2 and the second gasket 3 rest within the dimensions of the first recess 7 and the second recess 8 respectively. Further, it is preferred that the first depth 14 is equal to the second depth 15, so that there is symmetry in the improved dental milling device. Furthermore, according to the preferred embodiment, the first gasket 2 and the second gasket 3 are compressible. Preferably, the first gasket 2 and second gasket 3 raises the height of the center section 9 to just over 11 mm adding 1.5875 mm to each side of the center section 9. The first gasket 2 and the second gasket 3 compress when tightened in the holder back to ≈10 mm and fills any tolerance in the disc holder to ensure a secure fit. As seen in FIG. 1 through FIG. 7, the first gasket 2 and the second gasket 3 are annularly shaped (ring shaped). However, the first gasket 2 and the second gasket 3 may comprise any other shape and dimension, as long as the objectives of the present invention are fulfilled.

According to the preferred embodiment, the first gasket 2 and the second gasket 3 are attached to the disc 1 by an adhesive. However, any suitable adhesive/glue that will provide sufficient strength, viscosity, and drying time can be used to attach the gasket to the body of the disc. Any other fastening means that are known to one of ordinary skill in the art may also be employed as long as the intents of the present invention are not altered. Thus, the first and second circular rubber gaskets may be attached, using a suitable adhesive, to the upper and lower sides of the center section 9 in such a way that the gaskets act as a cushion between the disc 1 and the holding device. To that end, the first gasket 2 may be perimetrically mounted adjacent the first surface 4, and the second gasket 3 may be perimetrically mounted adjacent the second surface 5.

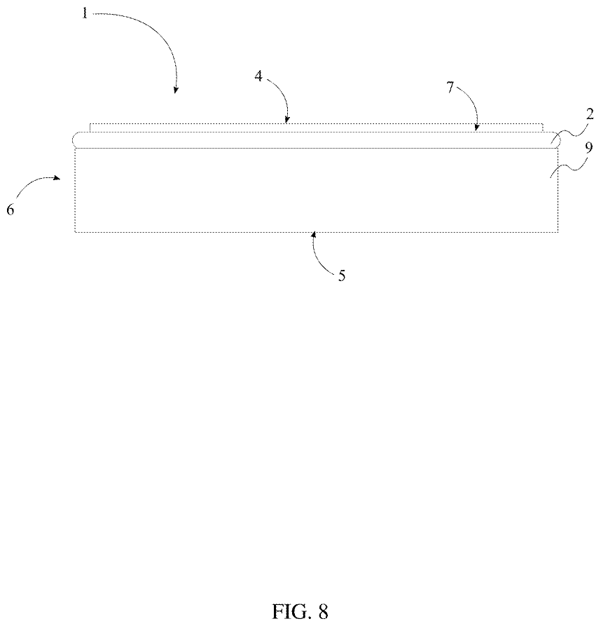

In an alternate embodiment, as seen in FIG. 8, the disc 1 may comprise only the first recess 7 wherein only the first gasket 2 is positioned along the first recess to provide the necessary cushion and dampening effect for the dental milling disc.

Although the invention has been explained in relation to its preferred embodiment, it is to be understood that many other possible modifications and variations can be made without departing from the spirit and scope of the invention as hereinafter claimed.

What is claimed is:

1. A dental milling disc device, comprising:
a disc;
a first gasket;
a second gasket;
the disc comprising a first surface, a second surface, and at least one lateral section;
the at least one lateral section comprising a first recess, a second recess, and a center section;
the first surface being positioned opposite to the second surface across the disc;
the first recess and the second recess laterally traversing into and around the at least one lateral section;
the first recess being positioned adjacent the first surface;
the second recess being positioned adjacent the second surface;
the first recess delineating a first lateral sidewall and an upper ledge;
the second recess delineating a second lateral sidewall and a lower ledge;
the first recess being positioned opposite to the second recess across the center section;
the first recess being positioned perimetrically around the first surface;
the second recess being positioned perimetrically around the second surface;
the first gasket being mounted along the first recess and adjacent the upper ledge; and
the second gasket being mounted along the second recess and adjacent the lower ledge.

2. The dental milling disc device of claim 1, comprising:
the first gasket being attached to the upper ledge and the first lateral sidewall; and
the second gasket being attached to the lower ledge and the second lateral sidewall.

3. The dental milling disc device of claim 1, comprising:
the first recess comprising a first depth; and
the second recess comprising a second depth.

4. The dental milling disc device of claim 3, comprising:
a first thickness of the first gasket being smaller than the first depth; and
a second thickness of the second gasket being smaller than the second depth.

5. The dental milling disc device of claim 3, comprising:
the first depth being equal to a second depth.

6. The dental milling disc device of claim 1, wherein the disc being circular in shape.

7. The dental milling disc device of claim 1, wherein the first gasket and the second gasket being compressible.

8. The dental milling disc device of claim 1, wherein the first gasket and the second gasket being annularly shaped.

9. The dental milling disc device of claim 1, wherein the first gasket and the second gasket being attached to the disc by an adhesive.

10. The dental milling disc device of claim 1, comprising:
the first gasket being perimetrically mounted adjacent the first surface; and
the second gasket being perimetrically mounted adjacent the second surface.

11. A dental milling disc device, comprising:
a disc;
a first gasket;
a second gasket;
the disc comprising a first surface, a second surface, and at least one lateral section;
the at least one lateral section comprising a first recess, a second recess, and a center section;
the first surface being positioned opposite to the second surface across the disc;
the first recess and the second recess laterally traversing into and around the at least one lateral section;
the first recess being positioned adjacent the first surface;
the second recess being positioned adjacent the second surface;
the first recess delineating a first lateral sidewall and an upper ledge;
the second recess delineating a second lateral sidewall and a lower ledge;
the first recess being positioned opposite to the second recess across the center section;
the first recess being positioned perimetrically around the first surface;
the second recess being positioned perimetrically around the second surface;
the first gasket being mounted along the first recess and adjacent the upper ledge;
the second gasket being mounted along the second recess and adjacent the lower ledge
the first gasket being attached to the upper ledge and the first lateral sidewall; and
the second gasket being attached to the lower ledge and the second lateral sidewall.

12. The dental milling disc device of claim 11, comprising:
the first gasket being attached to the upper ledge and the first lateral sidewall; and
the second gasket being attached to the lower ledge and the second lateral sidewall.

13. The dental milling disc device of claim 11, comprising:
the first recess comprising a first depth;
the second recess comprising a second depth;
a first thickness of the first gasket being smaller than the first depth;
a second thickness of the second gasket being smaller than the second depth; and
the first depth being equal to a second depth.

14. The dental milling disc device of claim 11, wherein the disc being circular in shape.

15. The dental milling disc device of claim 11, wherein the first gasket and the second gasket being compressible.

16. The dental milling disc device of claim 11, wherein the first gasket and the second gasket being annularly shaped.

17. The dental milling disc device of claim 11, wherein the first gasket and the second gasket being attached to the disc by an adhesive.

18. The dental milling disc device of claim 11, comprising:
the first gasket being perimetrically mounted adjacent the first surface; and
the second gasket being perimetrically mounted adjacent the second surface.
